(19) United States
(12) Patent Application Publication
(10) Pub. No.: US 2006/0064447 A1
(43) Pub. Date: Mar. 23, 2006

(54) Nutrition tracking method

(76) Inventor: Roman E. Malkov, Staten Island, NY (US)

Correspondence Address: MARY A WHITING, 214 SLOSSON AVE, STATEN ISLAND, NY, 10314, US

(21) Appl. No.: 11/205,525

(22) Filed: Aug. 17, 2005

Related U.S. Application Data
(60) Provisional application No. 60/602,462, filed on Aug. 18, 2004.

(51) Int. Cl. G06F 15/00

(52) U.S. Cl. 708/200

(57) ABSTRACT

A portable device which utilizes a method for tracking consumption of food calories, carbohydrates, fats, or proteins using a cell phone, personal data assistant, or hand held device. The user can record food intake; calculate basal metabolic rate; daily caloric needs; monitor calories, carbohydrates, protein or fats; and provide current metabolic state with corresponding exercise for weight control. The user can enter a timed physical activity to determine caloric balance between calories eaten and calories burned. Data is displayed for 7, 14, or 30 days, and can be Emailed to and synchronized with the user's personal computer or internet server

### CROSS REFERENCE TO RELATED APPLICATION

The present application claims priority from U.S. Provisional Patent Application Ser. No. 60/602,462, filed Aug. 18, 2004, which is hereby incorporated by reference herein in its entirety, now abandoned. The disclosure of this patent document, including the drawings, contains material which is subject to copyright protection, found in the copyrighted book, “The Carb Cycling Diet”, owned by the named inventor herein. The copyright owner, the named inventor herein, has no objections to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

The present invention pertains generally to nutrition and health, and more particularly to a method of tracking the user's consumption of calories, carbohydrate, fat, and protein throughout the day by using a software program which is loaded onto an electronic hand held device, such as a cell phone or personal data assistant (PDA). Once the information is saved on the user's software, at the user's option, it can be sent to the user's Email account in order to be downloaded, synchronized with the user's personal computer (PC), or send to an internet service provider (ISP).

2. Background of the Invention

Whether for losing weight, staying fit, or building muscles, many people wish to track their consumption of food products on hourly basis. The present invention makes this very convenient for people to keep track of personalized nutritional calculations and desired limits on a portable hand held device, such as a cell phone or personal data assistant (PDA). The present invention allows the user to use a software program which implements the tracking of the food products, and the food product's calories, carbohydrate, fat and protein content. The present invention allows user to monitor the metabolic states of anabolism and catabolism and to adjust exercise program according to it. For anabolism the user performs strength training/weight lifting. For catabolism the user performs aerobic exercise.

### SUMMARY OF THE INVENTION

The present invention is directed to a method for tracking the consumption of food product's calories, carbohydrate, fat and protein throughout the day. Software implementing the method is installed on the operating system of a hand held electronic device, such as a cell phone or PDA. In order to use the software, the user can choose selections by: 1) manually navigating through the menu selections by using the function keys on the hand held device's keypad, or 2) via voice recognition.

The software allows the user to track calorie, carbohydrate, fat and protein content of foods consumed throughout the day by selecting food names from a list of foods stored in a reference database and entering the amount eaten. The software adds up the calories, carbohydrate, fat and protein amounts, providing the user with balance and charts.

Based on user's input, the hourly balance of calories, carbohydrate, fat is calculated and presented to the user so he/she can adjust their food intake. If user sees that his/her intake is higher than expected (compared to previous days) he/she can cut food intake instantly. This approach prevents over consumption of calories, carbohydrates, fat in the diet in order to stay within the user's desired limits for these nutritional values (“Limit Values”).

In following the method of the present invention, the user initially enters the amount of calories that he or she wants to consume through the day. If the user does not enter this value, the balance is calculated based on the normal Basal Metabolic Rate (BMR) and Daily Calorie Needs (DCN), using Harris-Benedict formula based on user's input of gender, age, current weight, and height. The software displays charts of calories eaten and burned, as well as a history of calorie intake. The user enters his/her activities in an option entitled “Physical Activities.” The software calculates the burned calories based on the type of physical activity and time spent doing it.

In order to lose fat, the software program shows the number of calories needed to lose fat and the number of calories needed to build muscle. When the user loses weight the BMR and DCN diminishes. The user during the initial stage of entering their personal information, will enter the new weight to calculate new BMR and DCN.

The software calculates the carbohydrate, fat and protein content numbers, and provides a current balance along with charts. For example, if the user wants to consume 100 grams of carbohydrates a day, he/she can enter this number. This will be the Limit Value for carbohydrates. Throughout the day the user will enter any food that he/she consumes.

The software will show current amount of carbohydrates, protein or fat consumed, and the amount left to reach the Limit Values. This will ensure the user that the user does not exceed the user's desired amount. The software can display charts showing the amount of carbohydrates, protein or fat consumed for previous weeks and months as well.

Using the device, the user can:

1. Select consumed food from a list of foods stored in the software program's reference database and enter consumed amount. Display calorie, carbohydrate, fat and protein amounts for each food entered.

2. Enter the information from the Nutrition Facts available on food packaging into the program to be used in the calculations. These facts can be stored in the software program's reference database for future calculations by the user if the user consumes the same foods at a future meal.

3. Customize the software by deleting or adding calorie, carbohydrate, fat or protein calculation features.

4. Enter a new food item to the list of foods stored in the reference database.

5. Create a new food item (for example: salad) by mixing existing food items together. This feature works by selecting the “MiX mode” option, and selecting food items from the existing list of foods stored in the reference database. Once this new food item is created, it can be stored in the reference database for future use.

6. Search for an item in reference database of foods by its name.

7. Customize the reference database of foods by deleting never used items. The deleted item can be restored from the research database for future use.

8. Display current sum and balance for calories, carbohydrate, fat and protein.

9. Enter gender, height and weight to calculate BMR, and update the user's profile.

10. Calculate DCN and number of calories for fat loss and for building muscles (goal calories).

11. Enter the user's selected limit of calories, carbohydrate or fat amounts for this day (Limit Values).

12. Display a 7, 14 or 30 days chart.

13. Select a type of physical activity from the list of activities stored in the software's reference database for activities. Enter the activity time. Display the calorie value for this activity.

14. Display the calorie balance between calories eaten and calories burned.

15. Save the data in the software program.

16. At the user's option, if the electronic hand held device does not have sufficient memory to store data, the data can be sent to a server for storage, as well as retrieve the data from a server.

17. At the user's option, the voice recognition software can be accessed from a server (if the user's electronic hand held device does not have sufficient memory), or can be downloaded onto the electronic hand held device's disk space (if sufficient memory).

18. At the user's option, the user can Email the data to their Email account.

19. At the user's option, the user can synchronize the data with user's PC.

Note: Steps 15-19 are optional, the invention is self contained to the user's cell phone or other hand held electronic device.

Depending on the cell phone or PDA model and available disk space, the database for this software can be downloaded: (i) locally on a cell phone in a limited version, (ii) on the cell phone service provider's server, (iii) on a web based server, or (iv) on the user's home PC. Electronic hand held devices (i.e., cell phone or PDA), with sufficient storage space can download a full version of the reference database.

In the preferred embodiment of the invention, the data is saved locally on the cell phone or PDA. In alternate embodiment of the invention, the data can be:

(i) Emailed to the user's Email account for further processing by software available on user's PC. The PC version of this software has an extended reference database that performs more detailed calculations and analysis,

(ii) Exchanged with the service providers server via cell phone transmission, or

(iii) Exchanged with internet based server.

In the preferred embodiment of the invention, the convenience of having the software located on the user's cell phone or PDA provides the advantages and benefits of the user keeping track of the calories consumed, with a convenience of using the software anywhere while on the road, which leads to better adherence to most weight loss programs with regular usage of this software. The device also serves as an active assistant to weight loss at all times.

Other aspects of the present invention are apparent from the following detailed description, taken in conjunction with the accompanying drawings, which illustrate, by way of example, the principles of the invention.

### BRIEF DESCRIPTION OF THE DRAWINGS

FIG. 1, is a diagram of the primary screen with options “Personal Info”, “Food List”, “Activities Log” and “Summary”. The “Personal Info” option is selected and highlighted.

FIG. 2, is a diagram of the screen with data entered for the “Personal Info” option.

FIG. 3, is a diagram of the screen for the Limit Value for “Limit Calories”, “Limit Carbs” and “Limit Fat”.

FIG. 4, is a diagram of the screen for the “Customization” option for Nutrition Values. “Calories”, “Carbohydrates”, and “Fat” are selected and highlighted.

FIG. 5, is a diagram of the primary screen, with the “Food List” option selected and highlighted.

FIG. 6, is a diagram of the subsequent screens for “Food List” option selected, for the single food item, (i.e., “Bread and flour products”, and “Plain bagel”), selected and highlighted. Each column depicts a separate screen.

FIG. 7, is a diagram of the subsequent screens for “Food List” option selected, for a subsequent food item (i.e., “Milk and products”, “Philadelphia cheese”, “low fat”), and amount (i.e., “1 tbs”), selected and highlighted. Each column depicts a separate screen.

FIG. 8, is a diagram of the screen for a customized food item with the “MiX mode” option selected and highlighted.

FIG. 9, is a diagram of the subsequent screens for “MiX mode” option (i.e., “Vegetables”, “Green leaf”, and “1 cup”), selected and highlighted. Each column depicts a separate screen.

FIG. 10, is a diagram of the screens for “MySalad” option, (i.e., “MySalad”, and “2 cups”), selected and highlighted. Each column depicts a separate screen.

FIG. 11, is a diagram of the screens for a customized food item, (i.e., “pretzels”), and amount (i.e., “2 serving sizes”). Each column depicts a separate screen.

FIG. 12, is a diagram of the primary screen for the “Activities Log” option selected and highlighted.

FIG. 13, is a diagram of the subsequent screen for the “Activities Log” option, with “running” and “5.5 mph”, selected and highlighted, and “30 min” entered, totaling “Running 30 min 250 cal” highlighted. Each column depicts a separate screen.

FIG. 14, is a diagram of the primary screen, with the “Summary” option selected and highlighted.

FIG. 15, is a diagram of the screen with the “Balance” option selected and highlighted.

FIG. 16, is a diagram of the screen for results of the “Balance” option, depicting: “Your Calorie Limit”, “Calories Eaten”, “Balance to reach the limit”, “Your Carbs Limit”, “Carbs Eaten”, “Balance to reach limit”, “Your Fat Limit”, “Fat Eaten”, “Balance to reach the limit”, “BMR”, and “calories burned”.

FIG. 17, is a diagram of the screen with the “Compare” option selected and highlighted.

FIG. 18, is a diagram of the subsequent screen for the “Compare” option, with the “Calories” consumed screen selected. The time of the selection, (i.e., 12 PM), and the amount of calories consumed, (i.e., “1070”) are selected and highlighted.

FIG. 19, is a diagram of the subsequent screen for the “Compare” option, with the “Carbohydrates” consumed screen selected. The time of the selection, (i.e., 12 PM), and the amount of carbohydrates consumed, (i.e., “300”) are selected and highlighted

FIG. 20, is a diagram of the subsequent screen for the “Compare” option, with the “Fat” consumed screen selected. The time of the selection, (i.e., 12 PM), and the amount of fats consumed, (i.e., “20”) are selected and highlighted

FIG. 21, is a diagram of the screen for the “30 Day Summary” option selected, showing the catabolism and anabolism results for a 30 day period prior to the date of selection (i.e., “August”).

FIG. 22, is a diagram of the screens for the “Email report/Update” option selected and highlighted, with the subsequent screen for the “Email Report” option selected and highlighted. Each column depicts a separate screen.

FIG. 23, is a diagram of the screens for the “7-14-30 Day Summary” option selected and highlighted, with the subsequent screen for the “30 days” option selected and highlighted. Each column depicts a separate screen.

FIG. 24, is a diagram of the screen for activities during the day except exercise, with sitting, (i.e., “1950”), selected and highlighted, and also showing the daily calorie need (DCN), (i.e., “2600”), compared to the “calories you eat”, (i.e., “1070”), to determine “Current Calorie Deficit”, (and suggested activity (i.e., “Aerobic exercises”).

### DESCRIPTION OF THE PRIOR ART

Over recent years, there have been prior art devices which disclose inventions related to nutritional devices that assist the user in nutritional guidance. However, none of these prior art inventions is similar to the present invention, which can perform various functions, such as monitoring caloric, carbohydrate, fat intake, provide hourly comparison with previous days (hour by hour), provide current metabolic status of the user, suggest a correct type of exercise to correspond to the user's anabolic state (i.e., calorie intake exceeds the DCN which creates a positive calorie balance, weight lifting/strength training is recommended) or catabolic state (i.e, calorie intake less than DCN which creates a negative calorie balance, aerobic exercises are recommended).

Rather, these prior art devices have been used for behavior management, or grocery shopping, and are not giving user the complete outlook on their current metabolic state in relation to past and planned food intake. The present invention can be differentiated from the prior art, since the present invention specifically assists the user in obtaining two goals simultaneously: lose fat and build muscle mass. It can be achieved via alternating two metabolic states: anabolism with catabolism. Anabolism boosts metabolism and builds muscle, while catabolism creates fat and muscle loss.

The present invention is specifically support users of the inventor's “Carb Cycling Diet” copyrighted plan whose aim is to alternate anabolism and catabolism days; respectively, when they boost metabolism and build muscles (anabolism), with the days when they lose fat (catabolism).

The software shows to the user what metabolic state he/she currently is in, anabolism or catabolism. Accordingly, if user wants to continue to lose fat he/she is prompted to stay within catabolism. If the user wants to build muscles and boost metabolism, the user is prompted to stay within the anabolism state by consuming DCN or more calories.

Thus the software allows user to track the days when he/she was in a catabolism or anabolism state by presenting the past 30 days history chart. Anabolic days are shown in clear (or alternatively in red or any other color denoting positive calorie balance). Catabolic days are shown in solid (or alternatively in green or any other color denoting negative calorie balance).

The user can chose the specific calorie limit number (and number that falls within catabolism or anabolism) and then monitor his calorie intake against this number. This invention allows user to closely follow the inventor's copyrighted “Carb Cycling Diet” plan, that alternates days when user needs to be in catabolism (in order to lose fat) with days when user needs to be in anabolism (in order to boost metabolism and build muscles). No other inventions allow the user monitor anabolic and catabolic states and chose the correct type of exercise based on their metabolic state.

There are several patents which disclose devices related to nutritional counting, which can be differentiated from the present invention:

| Inventor | Patent Number | Date |
|---|---|---|
| Abrams, et. al. | 5,673,691 | Oct. 7, 1997 |
| Alabaster | 6,553386 | Apr. 22, 2003 |
| Ferro | 6,038,546 | Mar. 14, 2000 |
| Dugan | 6,811,516 B1 | Nov. 2, 2004 |

### OTHER REFERENCES

Carbohydrate counting device, Atkin's carb counter application with a Palm OS device, Pocket PC, and PC version, Akins's website http://www.atkins.com.

The instant invention is differentiated from Abrams; et. al., patent registration U.S. Pat. No. 5,673,691, dated Oct. 7, 1997, for “Apparatus to control diet and weight using human behavior modification techniques”, since the present invention uses a cell phone or personal data assistant (PDA), while Abrams, et. al., uses a self contained hand held computer. While the device of Abrams, et. al., prompts the user to perform behavior management, the present invention performs calculations in order for the user to maintain their daily nutritional limit values and caloric intake. While the present invention aids the user in changing their diet to obtain their specific goals; the present invention is not a behavior management tool.

The instant invention is differentiated from Alabaster's patent registration, U.S. Pat. No. 6,553,386, dated Apr. 22, 2003, for “System and method for computerized visual diet analysis and training”, since the present invention tracks calorie, carbohydrate and fat intake in real time throughout the day and provide a guidance for the user on his/her progress and metabolic status. Alabaster is lacking core functionality for those who wish to follow the inventor's copyrighted “Carb Cycling Diet” plan, because Alabaster only assists with catabolism (lose fat not build muscle).

The instant invention is differentiated from Dugan's patent registration U.S. Pat. No. 6,811,516 B1, dated Nov. 2, 2004, for “Method and Apparatus for Monitoring and Encouraging Health and Fitness”, since the present invention's software is downloaded onto and housed on the user's cell phone or PDA, and does not need the additional process of a accessing a web server for information. An additional advantage of the present invention over Dugan, is that the user can Email the data, send the data to a server, or download the data to the user's personal computer. The present invention is also different from Dugan, since it contains lists of food items, and the food's carbohydrate, protein, and fat content, rather than limited to grocery items, as referenced in Dugan. Dugan is lacking core functionality for those who wish to follow the inventor's “Carb Cycling Diet” plan, because Dugan only assists with catabolism (lose fat not build muscle).

The instant invention is differentiated from Ferro's patent registration U.S. Pat. No. 6,038,546 dated Mar. 14, 2000, for “System and method for creating a food order sales receipt identifying nutritional information of a customized meal”, since the present invention can be used for all types of food items the user consumes, and the food list which is stored in the software's reference database can be customized by the user. Ferro is limited to use of specific food items served to a patron of a meal preparation establishment. Additionally, the present invention is most convenient since it is housed on the user's cell phone or PDA, while Ferro is limited to a display system operated by the restaurant. Ferro lacks core functionality for those who wish to follow the inventor's copyrighted “Carb Cycling Diet” plan, because Ferro only assists with catabolism (lose fat not build muscle).

The instant invention is differentiated from Atkin's carb counter device, found on the Atkin's website http://www.atkins.com, since Atkin's counts carbohydrates and is tailored specifically to the Atkin's low carbohydrate diet. The instant device has a much broader application, as it calculates many different types of nutritional calculations, for various nutritional goals, in addition to the user's selected carbohydrate limit. Atkin's is lacking core functionality for those who wish to follow the inventor's copyrighted “Carb Cycling Diet” plan, because Atkins only assists with catabolism (lose fat not build muscle).

### OBJECTS AND ADVANTAGES

Accordingly, besides the objects and advantages stated above, several objects and advantages of the present invention, with installed software, implementing a method to used on a cell phone, PDA, or other hand held electronic device, as follows:

To provide for a device, from which the user can follow the present inventor's copyrighted “Carb Cycling Diet” plan.

To provide for a device, from which the user can easily access desired nutritional information for foods, from the software's reference database.

To provide for a device, from which the user can easily add nutritional information for foods, to the software's reference database.

To provide for a device, from which the user can easily add nutritional information for custom mixed foods, (such as salads), to the software's reference database.

To provide for a device, wherein the user can easily track and limit the user's consumption of calories, carbohydrates, fat and protein throughout the day, to meet the user's predetermined daily nutritional limits.

To provide for a device, which allows the user to switch between two metabolic states, anabolism or catabolism, and thus achieve the desired goals, fat loss or muscle building.

To provide for a device, wherein the user can store the nutritional information on the software's reference database for future use.

To provide for a device, wherein the user can customize the fields of desired nutritional information.

To provide for a device, which allows the user to conveniently use the device, which leads to better adherence to weight loss, gain, or maintenance program.

To provide for a device, wherein stored nutritional information can be sent directly to the user's Email or downloaded to the user's personal computer (PC), downloaded to the user's internet service provider's (ISP) server, or downloaded to the user's wireless telephone service provider's server.

To provide for a device, wherein the user can easily track the user's activities, and time spent on the activities, in order to determine the calories burned.

To provide for a device, wherein the user can easily track, in graphical format, the user's nutritional information in daily, 7, 14 or 30 day increments.

To provide for a device, wherein the user can easily calculate the user's BMR.

### DETAILED DESCRIPTION OF PREFERRED EMBODIMENT

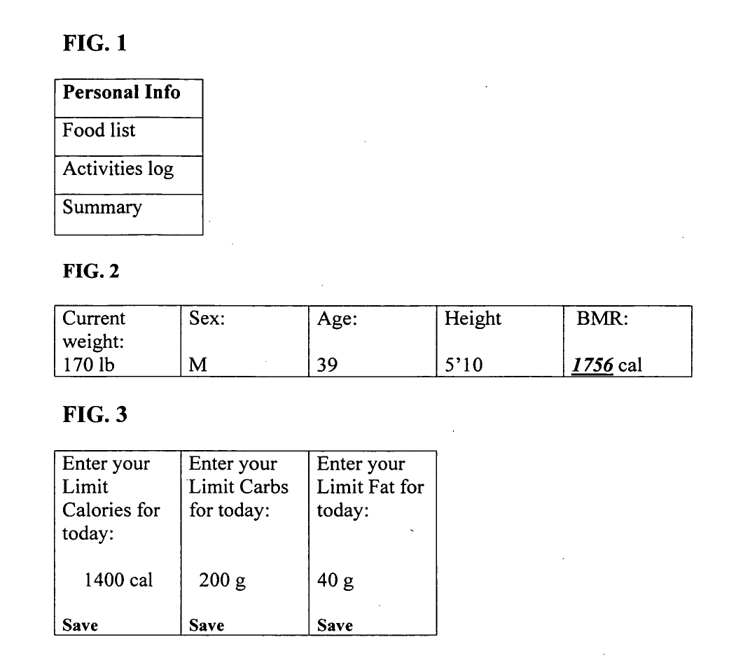

Referencing FIGS. 1-24, the following detailed description of the invention describes its structure and method of use. Each column in the FIGS. 1-24 depicts a separate screen.

FIG. 1 is a sequence of the method of the present invention's software menu as used on a user's cell phone, personal data assistant (PDA), or other hand held electronic device, which has the following primary four (4) menu options:
1. “Personal Info”,
2. “Food list”,
3. “Activities log”, and
4. “Summary”.

As shown in FIG. 5, when the user selects the option “Food list”, it is highlighted on software's menu screen (“screen”).

Once “Food List” is selected, the user can either: 1) manually navigate to the next software screen be selecting the cursor button which matches the navigation tools on the user's cell phone, PDA, or other hand held electronic device, or 2) use a voice activated command, if the user's hand held device is compatible with voice recognition software; which will automatically select “Food List”, and move to the next screen.

For the detailed description of the present invention, the term “selects” or “enters” shall mean that the user either manually or automatically via voice recognition selects a desired item and moves to the next screen.

For the detailed description of this invention, it shall be assumed that the device is compatible with the voice recognition software, and manually navigating to the next screen is not necessary for the operation of the software program.

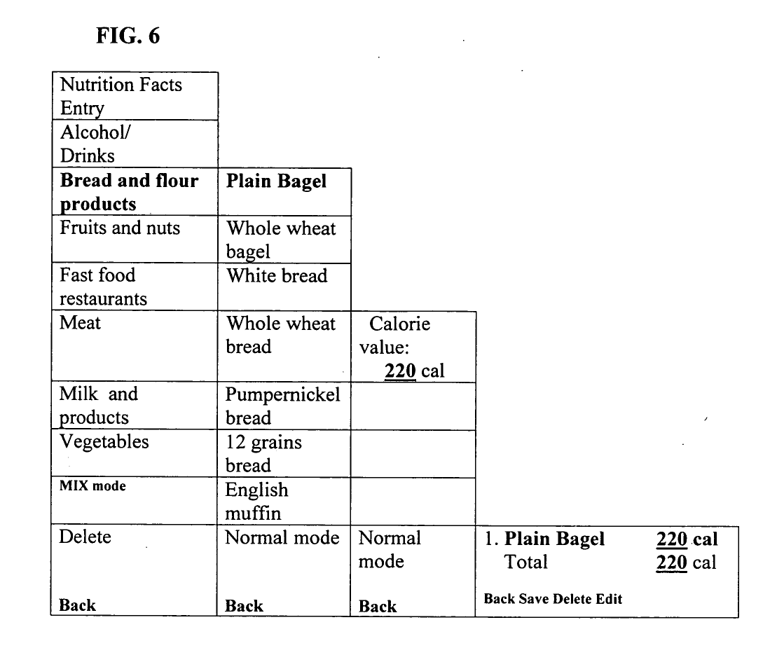

Once the user selects “Food list” the additional menu option, as shown in FIG. 6, (first column), entitled “Nutrition Facts Entry”, comprising: a plurality of food categories, such as “Alcohol/Drinks”, “Breads and flour products,” “Fruit”, “Fast food restaurants”, “Meat”, “Milk and milk products”, “Vegetables”, and “MIX mode”, are available for the user's selection. In FIG. 6, “Bread and flour products” has been selected by the user and is highlighted on the screen.

The food categories shown in FIG. 6, are for purposes of illustration only, as there are many categories of foods in the research database. The user can also create and customize food categories to add to the reference database.

As further shown in FIG. 6, the user also has the options to select “Delete”, and “Back”, if the user changes his/her mind and does not wish to select a food item at that time. If the user selects the “Back” option, the user will be brought back to the “Nutrition Facts Entry” option (shown in FIG. 6). If the user selects the “Back Button” again, the user will be brought back to the “Food List” option, (shown in FIG. 5). If the user selects “Delete”, the user will be brought back to the “Nutrition Facts Entry” option, (shown in FIG. 6).

As shown in FIGS. 1 and 2, in order to customize the program for the user's personal settings, the user performs the following operations. As shown in FIG. 1, the user selects the “Personal Info” option from the software menu. As shown in FIG. 2, a subsequent screen appears for the user to enter his/her sex, age, weight, height, (i.e., Sex: M, Age: 39, Height: 5′10″). As further shown in FIG. 2, the software automatically calculates and displays the BMR, (i.e., “BMR: 1756 cal”).

If manually navigating, the user then saves the information by selecting the designated function key to enter and save the information, such as selecting “Save”. Voice recognition will automatically save the settings. In FIGS. 1-24, all software calculated values are shown in bold and underlined text.

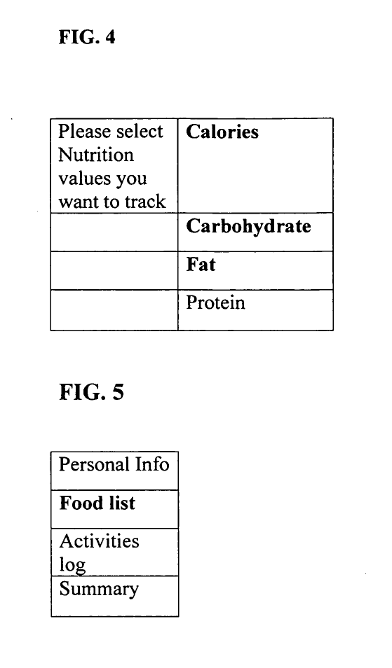

As shown in FIG. 4, the user can customize the tool by selecting the specific nutritional values the user desires to track. By default, the software is preset to track calories only.

The user can customize the tool to track any combination of, or all of the nutritional values “Calories”, “Carbohydrate”, “Fat” and “Protein.” As further shown in FIG. 4, the user has selected to track the highlighted “Calories”, Carbohydrate” and “Fat”, (shown highlighted).

After selecting the nutritional values to be tracked, the user either manually navigates to the designated function key to enter and save the information, such a selecting “Save”, or voice recognition will automatically save the settings.

As shown in FIG. 3, the user enters the daily “Limit Calories” (i.e. “Enter your Limit Calories for today: 1400 cal”), “Limit Carbs” (i.e., “Enter your Limit Carbs for today: 200 g”), and “Limit Fat” (i.e., “Enter your Limit Fat for today: 40 g”). These are “Limit Values”.

The user can customize “Limit Values” for calories, carbohydrates, and fats, in order to meet his/her individual goals. These “Limit Values” would be entered and saved as “Limit Calories”, “Limit Carbs”, and “Limit Fats.” There is no “Limit Proteins”, since this is not a practical value.

These “Limit Values” are optional. If “Limit Values” are not entered, the software will default to anabolism, which is a positive calorie balance, and catabolism which is a negative calorie balance, as related to the user's DCN.

After selecting “Limit Calories”, the user either manually navigates to the designated function key to enter and save the information, such as selecting “Save”, or voice recognition will automatically save the settings.

After the user has entered the above customized information into the software program, the user is ready to enter the type and amount of foods eaten in order to compute the desired nutritional calculations which will assist the user in meeting his/her individual nutritional goals, and “Limit Values.” If the food item is not a mixture (such as a salad), but a single food type (such as a plain bagel), the user performs the following steps in order to enter the information and calculate the nutritional values:

1. As shown in FIG. 5, the user selects “Food list” from the primary software menu, which is highlighted.

2. As shown in FIG. 6, (first column), the user selects the desired food item from the list stored on the resource database. For example, the user selects “Bread and flour products”, which is highlighted.

3. After the above selection, the user has the option to select the “Back” or “Delete” options, either manually or by voice recognition.

4. When the user navigates to the next screen, (this would be automatic with voice recognition), a choice of food items is shown, and the user selects “Plain Bagel” as a food item, (second column), which is highlighted.

5. After the above selection, the user has the option to select the “Back” option, either manually or by voice recognition.

6. When the user navigates to the next screen (this would be automatic with voice recognition), the user is prompted to enter the amount eaten in grams, oz, cups, pieces or serving sizes. For bagels, the food item automatically is entered as one. If the user eats two bagels, the process described above is repeated.

7. As further shown in FIG. 6, (third column), the software calculates the calorie, fat, carbohydrate content of this food item, and shown on the menu. For “one plain bagel”, the calorie value is “220 cal.” As shown in the forth column. “Plain Bagel” and “220 cal” are highlighted. In FIG. 6, only the Calorie value was tracked.

8. After the above selection, the user has the option to select the “Back” option, either manually or by voice recognition.

9. Once all the information is entered, (i.e., “Bread and flour Products”, “Plain Bagel”, and “220 cal”), the user then saves the information by navigating using the designated function key to enter and save the information, such as selecting “Save.” This would be automatic with voice recognition.

10. Also shown on FIG. 6, are the function designations, “Back”, “Delete” and “Edit”, are all alternative options the user can make, instead of saving the data. This would be automatic with voice recognition. The “Normal Mode” is the default mode when the user has not chosen the “MiX mode”.

11. As further shown on FIG. 6, the software calculates and the menu displays the list of foods eaten that day with the corresponding selected nutritional values information for each food eaten (i.e., calories, protein, carbohydrates and fat, or a combination thereof). In FIG. 6, the caloric value was the only value selected by the user to track.

12. The user can either go back in the process, or save, delete or edit an item, by selecting the “Back”, “Save”, “Delete” or “Edit” button. This would be automatic with voice recognition.

13. As further shown in FIG. 6, during the selection and entering of the selected food category (“Bread and flour products”), the selection and entering of the selected food item (Bagel”), and the display of the calories (“Calorie Value 220 cal”), the user can select the “Back” option, if the user changes his/her mind and wants to go back one or more steps in the process, before saving the information. This would be automatic with voice recognition.

14. Once the food item information is saved, the software automatically returns to the option entitled “Food list” on the menu, (as shown in FIG. 5), in order for the user to input the next food item into the software program. This would be automatic with voice recognition.

If the user adds the food item “Philadelphia cheese” (a food item which is preloaded in the reference database), to the bagel, the user performs the following steps.

1. As shown in FIG. 5, the user selects the “Food list” option from the primary software menu, which is highlighted.

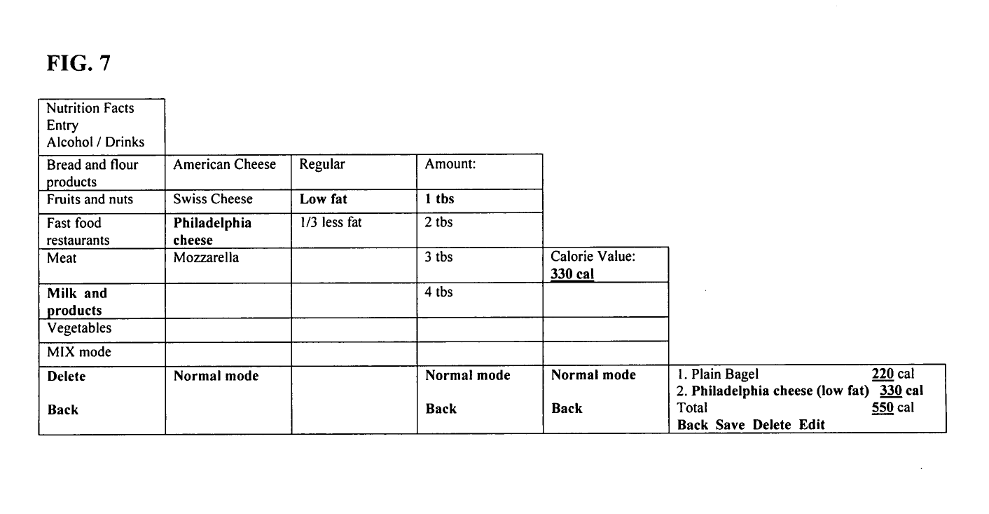

2. As shown in FIG. 7, (first column), the user selects the desired food item from the list stored on the resource database. For example, the user selects “Milk and products”,

3. After the above selection, the user has the option to select the “Back” or “Delete” options, either manually or by voice recognition.

4. When the user navigates to the next screen, a choice of food items is shown, and the user selects “Philadelphia cheese” as a food item, (second column), which is highlighted.

5. After the above selection, the user has the option to select the “Back” option, either manually or by voice recognition.

6. When the user navigates to the next screen (this would be automatic with voice recognition), the user selects the type of Philadelphia cheese, (i.e., “low fat”), (third column), which is highlighted.

7. After the above selection, the user has the option to select the “Back” option, either manually or by voice recognition.

8. When the user navigates to the next screen, the user is prompted to enter the amount eaten in grams, oz, cups, pieces or serving sizes, (i.e., 1 tablespoon). The user selects “1 tablespoon” (fourth column), which is highlighted.

9. As further shown in FIG. 7, the software calculates the calorie, fat, carbohydrate content of this food item, and shown on the menu. For “Philadelphia cheese, low fat, 1 tablespoon”, the calorie value is “330 cal” (fifth column). In FIG. 7, only the caloric value was tracked.

10. After the above selection, the user has the option to select the “Back” option, either manually or by voice recognition.

11. Once all the information is entered, (i.e., “Milk and products, Philadelphia cheese, low fat, 1 tablespoon, 330 cal”), the user then saves the information by navigating using the designated function key to enter and save the information, such as selecting “Save.” This would be automatic with voice recognition.

12. Also shown on FIG. 7, are the function designations, “Back”, “Delete” and “Edit”, are all alternative options the user can make, instead of saving the data. This would be automatic with voice recognition. The “Normal Mode” is the default mode when the user has not chosen the “MiX mode”.

13. As further shown on FIG. 7, the software calculates and the menu displays the list of foods eaten that day (sixth column), with the corresponding selected nutritional values information for each food eaten (i.e., calories, protein, carbohydrates and fat, or a combination thereof). In FIG. 7, the caloric value was the only value selected by the user to track.

14. The user can either go back in the process, or save, delete or edit an item, by selecting the “Back”, “Save”, “Delete” or “Edit” button. This would be automatic with voice recognition.

15. As further shown in FIG. 7, during the selection of the desired food category (“Milk and products”), and the selection of the desired food item (“Philadelphia cheese, low fat, 1 tablespoon”), and the display of the caloric value (“330 cal”), the user can select the “Back” option, if the user changes his/her mind and wants to go back one or more steps in the process, before saving the information. This would be automatic with voice recognition.

16. Once the food item information is saved, the software automatically returns to the option entitled “Food list” on the menu, (as shown in FIG. 5), in order for the user to input the next food item into the software program. This would be automatic with voice recognition.

17. If the user saves this information, as shown on FIG. 7, the software automatically recalculates the total amount of the food items entered for that day, “Total 550”, (sixth column). Once the user saves this information, the software automatically returns to the list of food items.

If the next food to be eaten is a mixture of different types of foods, such as a salad, comprised of red peppers, olives, and green leaf lettuce, the steps described below are shown on FIGS. 5, 8, 9, and 10. In order to enter the next food which is eaten, the user performs the following steps:

1. As shown in FIG. 5, the user selects “Food list” from the primary software menu, which is highlighted.

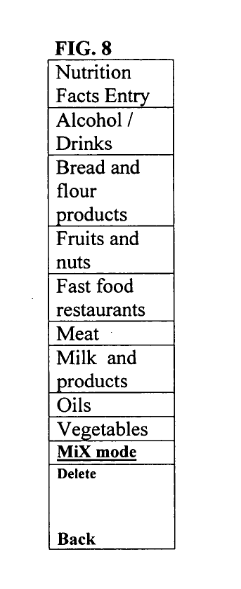

2. As shown in FIG. 8, if the next food item is a mixture of different types of foods, such as a salad, the user selects the option entitled “MiX mode”, from the software menu. The selected “MiX mode” option will be highlighted on the software menu screen, as long as the “MiX mode” is active.

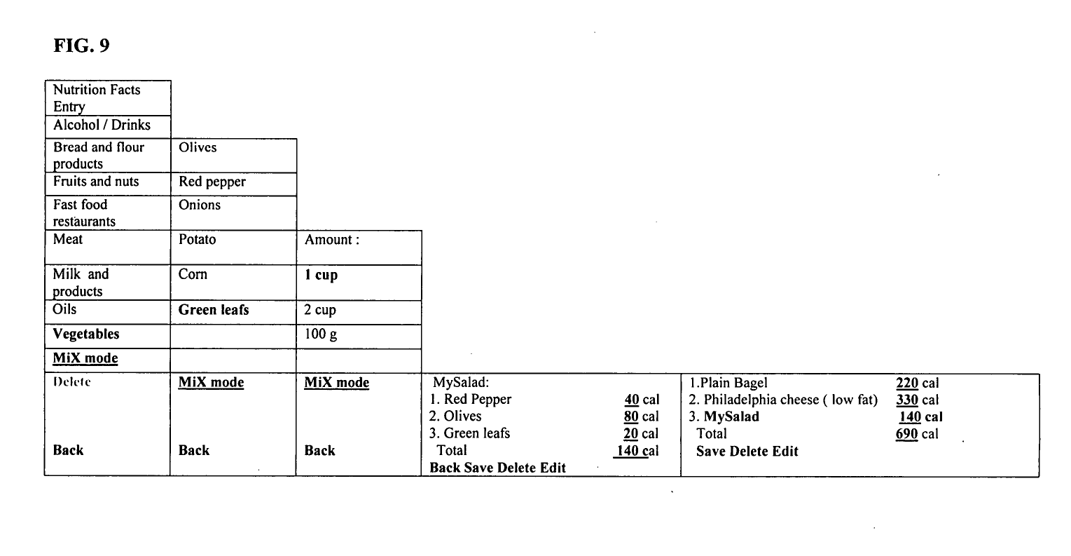

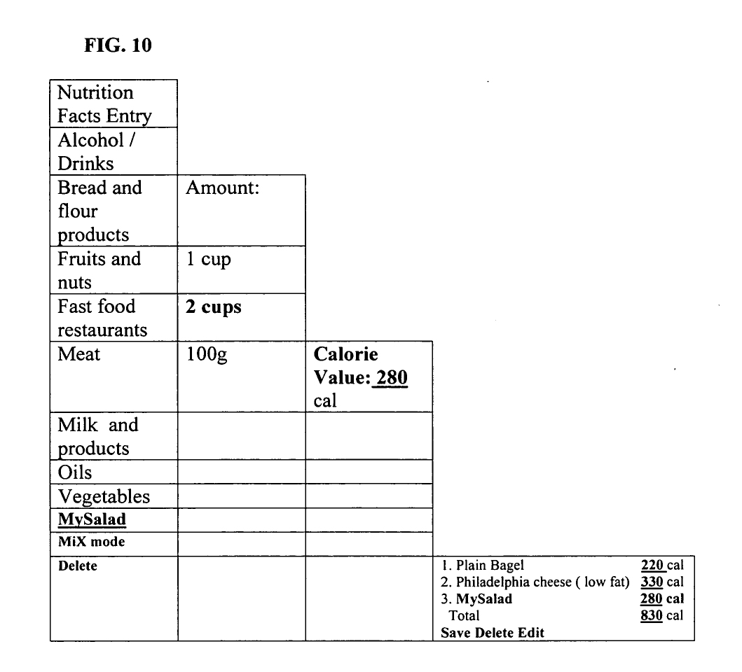

3. While in the “MiX mode” as shown in FIGS. 9 and 10, the user is prompted to enter the mix name (i.e., “MySalad”). The selection “MySalad” is highlighted.

4. The user then saves the information by navigating to the designated function to enter and save the information, such as clicking on a “Save” button. This would be automatic with voice recognition.

5. As shown on FIG. 9, once the software returns to the list of food items, such as “vegetables”, (first column), the individual food items are selected as “MySalad” components following the same steps as entering the “Plain Bagel” or “Philadelphia Cheese” as described above.

6. As shown in FIG. 9, for the “MySalad” created by the user, its ingredients, “green leaf”, (second column), “1 cup”, (third column), “red pepper, 40 cal”, “olives 80 cal”, “green leafs 20 cal” for a total of “Total 140 cal”, (fourth column), are entered by using steps above for foods in the reference database.

7. The user prompted by the software to enter the option of amount eaten in grams, oz, cups or pieces. For example, as shown in FIG. 10, for “MySalad” (first column), the user would enter “Amount: 2 cups”, (second column) The user then saves the information by navigating to the designated function key to enter and save the information, such as clicking on a “Save” button. This would be automatic with voice recognition.

8. The software automatically returns to the list of food items.

9. The software automatically displays the list of food in the “MiX mode” option with nutrition information. As shown in FIG. 10, this is “Calorie Value: 280 cal”, (third column). The user has the option to either “Save”, “Delete” or “Edit” any of the selected items which make up the mixture by navigating to the designated function to enter and save the information, such as clicking on an “Save”, “Delete” or Edit”. This would be automatic with voice recognition. Or the user can edit the “MySalad” food item, by adding a new ingredient, such as by adding corn to the salad.

10. As shown in FIG. 10, if the user chooses to “Save” the item, this adds the “MiX mode” name (i.e. MySalad”) to the list of food items, (first column).

11. As further shown in FIG. 10, the software displays the list of food eaten today with nutrition information. The user then either Saves, Deletes or Edits the information, by navigating through the designated function to enter and save the information, such as a “Save”, “Delete” or Edit” button. This would be automatic with voice recognition.

The nutritional information for most food is already loaded into the software. For example, as shown in FIG. 7, the nutritional information for “1 tablespoon of low fat Philadelphia cheese” is pre-loaded into the software's reference database, in the reference database's category “Milk and products.”

However, when the user desires to know the nutritional facts concerning food items which do not have their nutritional information already automatically loaded into the software, (such as “Pretzels”), the user can enter and calculate this for one serving, by performing the following steps:

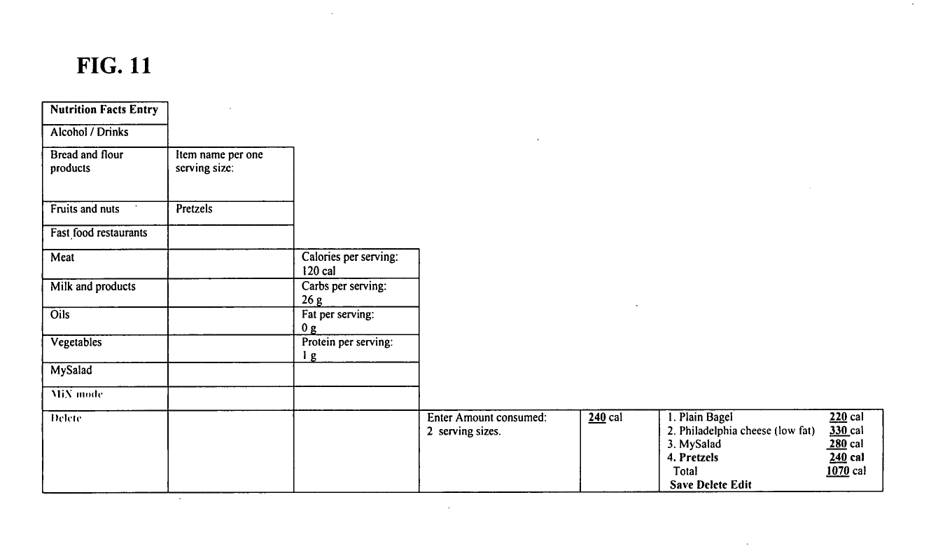

1. As shown in FIG. 1, the user selects the “Food List” option from the software menu, which is highlighted. The same method as described above brings the user to the options shown in FIG. 11.

2. As shown in FIG. 11, the user selects the “Nutrition Facts Entry”, which is highlighted, (first column)

3. As shown in FIG. 11, the user is prompted to enter the food item, (for example, as shown in second column, the user enters “Pretzels”), and then the food item's serving size (for example, in the third column, the user enters “2 serving sizes”). The user then saves the information by navigating to the designated function to enter and save the information, such as clicking on the “Save” button. This would be automatic with voice recognition.

4. As further shown in FIG. 11, the user is prompted to enter information for 1 serving size from the nutrition facts on the package. For example, the user enters: “Calories per serving: 120 cal”, “Carbs per serving: 26 g”, “Fat per serving: 0 g”, and “Protein per serving: 1 g”, (third column).

5. As further shown in FIG. 11, the user is prompted about the number of serving sizes consumed. For example, the user enters: “enter amount consumed: 2 serving sizes”, (fourth column).

6. As further shown in FIG. 11, the software automatically displays the nutritional info. For example, the software menu displays, in addition to all other foods eaten that day: “Pretzels 240 cal”, (fifth column), and recalculates the total amount of calories for the day (“Total 1070 cal”) (sixth column).

7. The user can either save the information, for the food item added to the food list, or can delete the item from the food list.

8. The software automatically returns to the list of food items.

When the user desires to know the caloric values for activities performed that day, the following steps are performed:

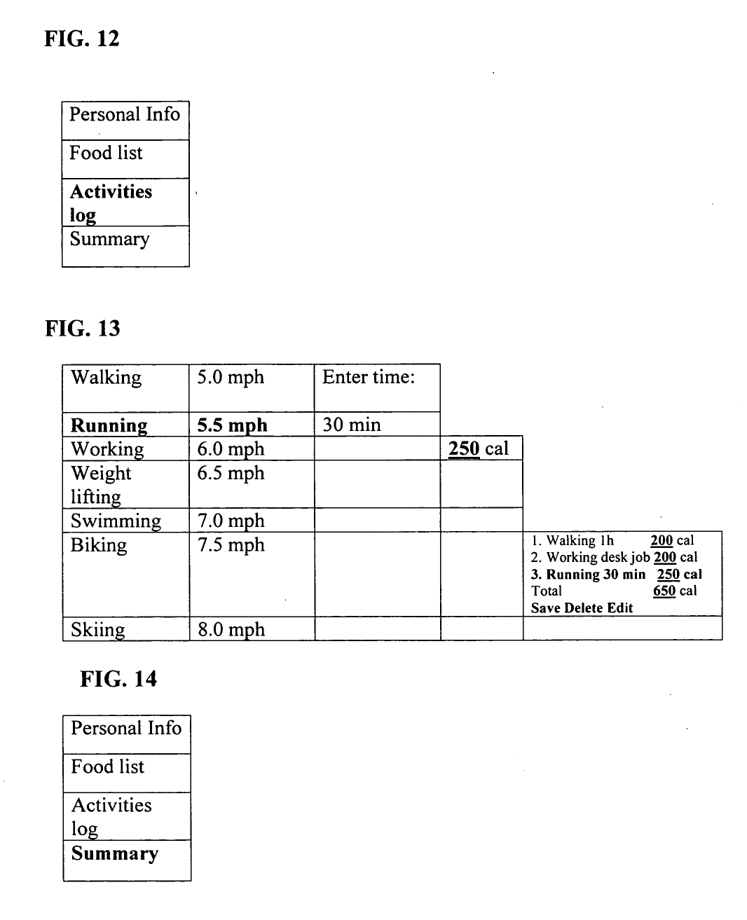

1. As shown in FIG. 12, the user selects the “Activities Log” option from the software menu, which is highlighted.

2. As shown in FIG. 13, the user selects an activity from the reference database of activities in the software (i.e., “Running”), which is highlighted, (first column).

3. As shown further in FIG. 13, the user selects the miles per hour (“5.5 mph”), for the “Running Activity”, which is highlighted, (second column).

4. As further shown in FIG. 13, the user selects the time (“30 min”), for the activity, (third column).

5. The software calculates this activity burns 250 calories (“250 cal”), (fourth column).

6. The user can either save the information for the activity added to the activity list, by navigating to the “Save” function key, or can go back, delete, or edit the item from the activity list, by selecting the “Back”, “Delete” or “Edit” functions keys (shown in FIG. 13). Voice recognition is automatic.

7. These steps can be repeated in order for the user to enter all their daily activities.

8. The software displays the list of activities performed for today with their calorie values. As shown in FIG. 13, the total daily activities loaded were “Walking 1 hr 200 cal”, “Working desk job 200 cal”, “Running 30 min 250 cal”, for a total of “Total 650 cal”, (fifth column).

When the user desires to see a summary of activities, and selected nutritional calculations, such as calories eaten, calories burned, and the current balance for the day, the user performs the following steps:

1. As shown in FIG. 14, the user selects the “Summary” option from the software menu, which is highlighted.

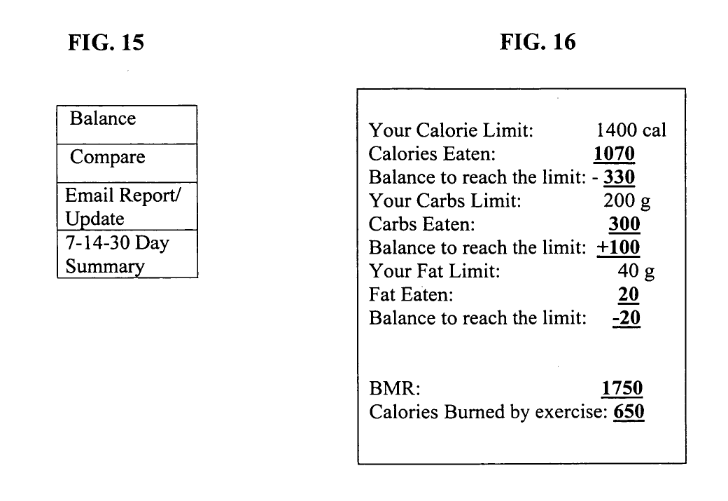

2. As show in FIG. 15, the software automatically moves to the next screen, wherein the user selects the “Balance” option, which is highlighted.

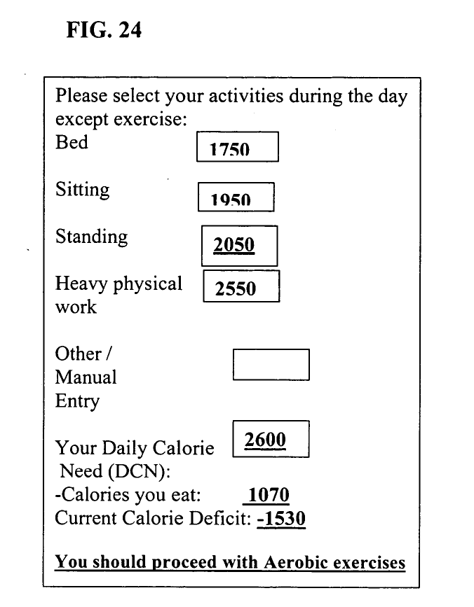

3. As shown in FIGS. 16 and 24, the software automatically moves to the next screen, where the daily limit (“1400 cal”), calories eaten (“1070”), balance to reach the limit (“−330”), BMR (“1750 cal”), calories burned by exercise (“650”), and after all data is shown, the software automatically moves to the next screen, as shown in FIG. 24. The Limit Values and Balance to reach the limit are meant for user's convenience. It helps user to keep desired food intake

4. Once user is on the screen shown in FIG. 24, the user selects his activities in addition to exercise, for example, “sitting” is highlighted.

5. As further shown in FIG. 24, the software calculates the “Current Calorie Deficient” or “Current Calorie Surplus” as follows:
i. the screen displays the user's DCN, as shown by “Your Daily Calorie Need (“2600 cal”)”,
ii. the calories eaten (“1070”) is subtracted from the DCN,
iii. the Current Calorie Deficit (“−1530 cal”)” is displayed (If there was a surplus, a “Current Calorie Surplus” would be displayed), and
iv. based on last value (for a Current Calorie Deficit this is a negative value) the software advices Aerobic exercises. (If the “Current Calorie Surplus” equals to zero or a positive value the software would advise strength training/weight lifting exercises).

The “Current Calorie Deficit” is the value that defines if user will lose fat or not. It is calculated by software as a difference between DCN and number of calories eaten. The bigger the Current Calorie Deficit value the more fat the user will lose. To help user to lose fat or build muscles the Limit Calories, Limit Fat options are included in the present invention's software. These Limit values are for user's convenience only. It helps the user to achieve the desired calorie deficit or calorie surplus. The user can create a bigger calorie deficit if he/she will set Limit Calorie to a lower number.

The user can achieve fat loss if the user sets their Limit Calories number below DCN. The user can achieve the anabolic state if the user sets their Limit Calorie number above DCN.

If the user eats equal or more calories than DCN, a Current Calorie Surplus (positive value) will be shown. In this case the software will advise strength training/weight lifting exercises. The combination of both anabolism and strength training/weight lifting allows the user to build muscles.

If the user wants to compare previous day's nutrition information and the current status matching hour by hour, the following steps are performed:

1. As shown in FIG. 14, the user selects the “Summary” option from the software menu, which is highlighted.

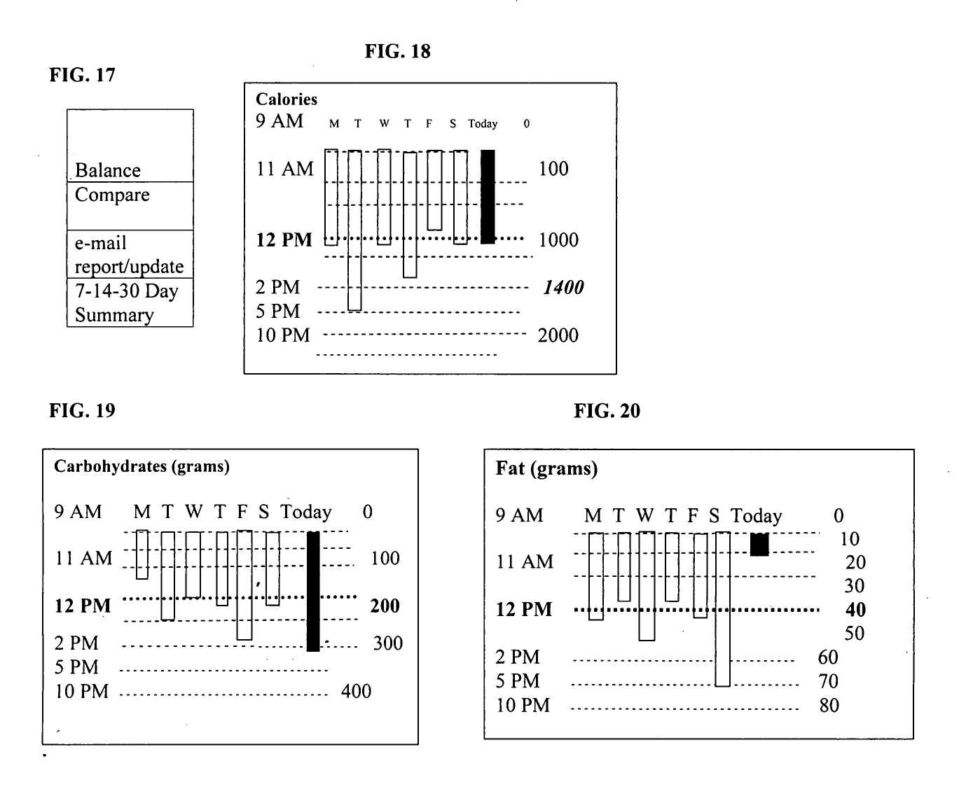

2. As shown in FIG. 17, the software automatically moves to the next screen, where the user selects the “Compare” option, which is highlighted.

3. As shown in FIG. 18, the software automatically moves to the next screen, wherein the software graphically displays the previous week's nutritional information and the current values for the present matching hour by hour. The current day and time is “Sunday, 12 PM”, which is highlighted. FIG. 18 displays calories since the user picked “Calories” as a selected category in FIG. 4.

4. As shown in FIGS. 19 and 20, the same steps as above would be performed, and if the user selected carbohydrates and fat, as shown in FIG. 4, these values are also shown graphically.

5. There is no figure shown for protein, since, in FIG. 4, protein was not selected.

If the user wants to send the information to the user's Email, the following steps are performed:

1. As shown in FIG. 14, the user selects the “Summary” option from the software menu, which is highlighted.

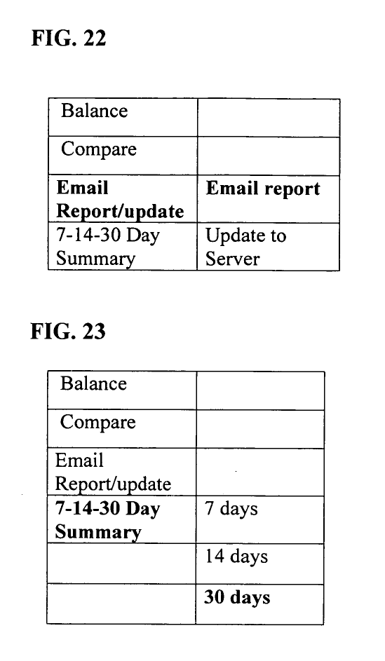

2. As shown in FIG. 22, the software automatically moves to the next screen, where the user selects the “Email report/Update” option, which is highlighted (first column).

3. On the subsequent screen, the user selects “Email report”, which is highlighted (second column).

4. The software automatically sends the information to the user's Email account, which is preprogrammed into the cell phone's or PDA's software.

If the user wants to see 7, 14, or 30 days summary, the following steps are performed:

1. As shown in FIG. 14, the user selects the “Summary” option from the software menu, which is highlighted.

2. As shown in FIG. 23, the software automatically moves to the next screen, where the user selects the “7-14-30 Day Report” option, which is highlighted, (first column).

3. As further shown in FIG. 23, the user selects from the subsequent screen the “30 days” option, which is highlighted (second column).

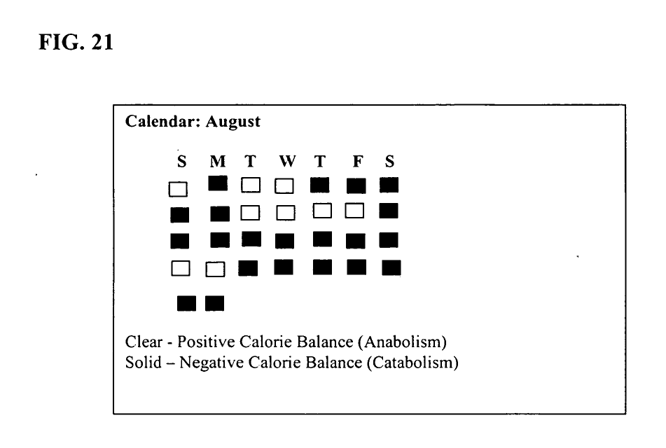

4. As shown in FIG. 21, when the user selects the “30 days” option, the August calendar appears, since the user entered the information on August 31. Clear boxes denote positive calorie balance (anabolism), and solid boxes denote negative calorie balance (catabolism).

The preferred embodiments of the invention described herein are exemplary and numerous modifications, variations, and rearrangements can be readily envisioned to achieve an equivalent result.

I claim:

1. A method of portable computerized nutritional aid, comprising a software program with a menu comprising the following plurality of options entitled:
i. Personal Info,
ii. Food List,
iii. Activities log, and
iv. Summary,
whereby, a user can calculate and track desired nutritional values, comprising the following steps:
i. when a user enters and saves individualized personal information, comprising gender, weight, and height, into said Personal Info option, said software program automatically calculates and displays said user's basal metabolic rate, which is used to calculate said user's desired daily nutritional limit value, such as daily limit value of caloric intake of foods eaten as compared to said basal metabolic rate, which is saved into said software program, in order to regulate weight, and, in addition to said daily limit value for caloric intake, said user can enter and save selected nutritional daily limit values for carbohydrates, fat, and protein intake, and
ii. whereby said software contains a reference database of caloric, carbohydrate, protein and fat content for plurality of food items, wherein, when said user selects said Food List option, and subsequently selects food items from said plurality of food items, and subsequently selects and saves the serving size of said selected food items, said software program tracks said selected values for said selected food items, which are caloric value, and carbohydrate, fat and protein nutritional values, as compared to said saved selected nutritional daily limit values, in order to determine if said user's daily intake of selected food items meet the desired nutritional daily limits values.

2. A method as described in claim 1, wherein said user can add to said reference database said caloric, carbohydrate, protein and fat content per serving size of food items, which are not preprogrammed into said reference database.

3. A method as described in claim 1, wherein said user can add to said reference database food items which comprise a combination of plurality of food items, such as salads.

4. A method as described in claim 1, whereby said software contains a reference database of activities, wherein said user selects said Activities Log option from said menu, and selects and saves an activity and the time performed for said activity from said reference database, thereby causing said software program to calculate said daily caloric value for said selected activity.

5. A method as described in claim 1, whereby, after said user selects said Summary option from said menu, said user subsequently selects an option for the purpose of causing said software program to automatically update said saved information from a server, which displays the calories eaten, calories burned and current balance of unused calories.

6. A method as described in claim 1, whereby, after said user selects said Summary option from said menu, said user subsequently selects an option for the purpose of causing said software program to automatically save the data and graphically display said nutritional information, in hourly, 7, 14 or 30 day increments.

7. A Method as describe in claim 1, whereby, after said user selects said Summary option from said menu, said user subsequently selects an option for the causing said software program to automatically send said nutritional information to said user's Email.

8. A method as described in claim 1, whereby, after said user selects said Summary option from said menu, said user subsequently selects an option for the purpose of causing said software program to automatically update said data to a server.

9. A method as described in claim 1, whereby, after said user selects said Summary option from said menu, said user subsequently selects an option for the purpose of causing said software program to automatically select an activity which corresponds to an anabolic metabolic state or a catabolic metabolic state.

10. A method as described in claim 1, wherein said software program is housed on an electronic means for storing said software program, such as an cell phone, or personal data assistant.
